(19) United States
(12) Patent Application Publication
(10) Pub. No.: US 2009/0124372 A1
(43) Pub. Date: May 14, 2009

(54) ASSET MANAGEMENT OF DOWNLOADABLE GAMING COMPONENTS IN A GAMING SYSTEM

(76) Inventors: Mark B. Gagner, West Chicago, IL (US); Alicia Johnson, Chicago, IL (US); John A. Beatty, Reno, NV (US); Christopher W. Blackburn, Reno, NV (US)

Correspondence Address: SCHWEGMAN, LUNDBERG & WOESSNER/WMS GAMING, P.O. BOX 2938, MINNEAPOLIS, MN, 55402, US

(21) Appl. No.: 11/912,921

(22) PCT Filed: May 1, 2006
(86) PCT No.: PCT/US06/16354

§ 371 Date: Jun. 27, 2008

Related U.S. Application Data
(60) Provisional application No. 60/676,553, filed on Apr. 29, 2005.

(51) Int. Cl. A63F 9/24; A63F 13/00

(52) U.S. Cl. 463/29; 463/43

(57) ABSTRACT

Systems and methods provide mechanisms for updating software assets on a gaming machine (100.1 and 100.2). The gaming software assets may include banner content, advertising content, denomination data, pay table, language data, video content, audio content, episodic game data, wagering game software, operating system software, device driver software and device firmware. The system and methods compare software assets to be placed (408) on a gaming machine to software assets already on the gaming machine. Only those software assets that are not currently present are downloaded to the gaming machine.

### RELATED APPLICATION

This application claims the priority benefit of U.S. Provisional Application Ser. No. 60/676,553 filed Apr. 29, 2005, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Gaming machines may be operated as a stand alone unit, or linked in a network of some type to a group of gaming machines. As technology in the gaming industry progresses, more and more gaming services are being provided to gaming machines via communication networks that link groups of gaming machines to a remote central server computer that provides one or more gaming services. As an example, gaming services that may be provided by the remote computer to a gaming machine via a communication network of some type include player tracking, accounting, cashless award ticketing, lottery, progressive games and bonus games. In addition, gaming machines are evolving into gaming platforms where the gaming services and game play options provided on the gaming machines may be dynamically configured. Thus, the number and type of game services and game play options offered on a particular gaming machine may vary with time.

A gaming entity may operate hundreds, thousands or ten of thousands of gaming machines. Since gaming is allowed in many locations throughout the world, casinos may have games distributed over a wide geographic area. Within casinos, the gaming machines may be connected via one or more dedicated networks. Servers are usually located in a backroom of the casino away from the casino floor.

There is a growing trend to provide new software and data by downloading the software or data to the gaming machine from one or more central servers linked to the gaming machine. In addition, the software or data may be downloaded as individual parts of a complete configuration. This downloading technique facilitates modifications to the game software in that it does not require removal of the gaming machine and does not require service personnel to visit the gaming machine site or the gaming machine itself. However, managing gaming machines that can receive downloaded software and data can be a problem. Determining which software and data belongs on which gaming machine can be a daunting task, especially in a gaming establishment with numerous gaming machines, or in environments where numerous gaming machines exist across multiple gaming establishments. The complexity of the problem and the number of potential configurations increases rapidly with the number of gaming machines that can receive downloadable software and data. For example, managing the available downloadable components that may become part of a configuration can be a daunting task. Further, managing downloadable components to make sure they are compatible with one another can also be problematic.

Additionally, gaming applications may be made up of multiple downloadable software assets such as executables, video data, and audio data. Often an updated gaming application reuses a majority of the component assets. Downloading an entire package of software assets with each update can be wasteful of both network bandwidth and gaming machine processor time.

### SUMMARY

The above-mentioned shortcomings, disadvantages and problems are addressed by the embodiments of the present invention, which will be understood by reading and studying the following specification.

Systems and methods provide mechanisms for updating software assets on a gaming machine. The gaming software assets may include banner content, advertising content, denomination data, pay table, language data, video content, audio content, episodic game data, wagering game software, operating system software, device driver software and device firmware. The system and methods compare software assets to be placed on a gaming machine to software assets already on the gaming machine. Only those software assets that are not currently present are downloaded to the gaming machine.

The specification describes systems, methods, and computer-readable media of varying scope. In addition to the aspects and advantages described in this summary, further aspects and advantages of the embodiments of the invention will become apparent by reference to the drawings and by reading the detailed description that follows.

### BRIEF DESCRIPTION OF THE DRAWINGS

FIG. 1 is a perspective view of a gaming machine according to an example embodiment.

FIG. 2 is a block diagram of processing components of a gaming machine according to an example embodiment.

FIG. 3 is a block diagram of major software components of a gaming machine according to an example embodiment.

FIG. 4 is a block diagram of a system of gaming machines and gaming related machines according to an example embodiment.

FIG. 5 is a flowchart illustrating methods of providing software components to a machine in the network of FIG. 4.

FIG. 6 provides two example lists of software components used to illustrate the operation of embodiments of the invention.

### DETAILED DESCRIPTION

In the following detailed description of exemplary embodiments of the invention, reference is made to the accompanying drawings which form a part hereof, and in which is shown by way of illustration specific exemplary embodiments. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

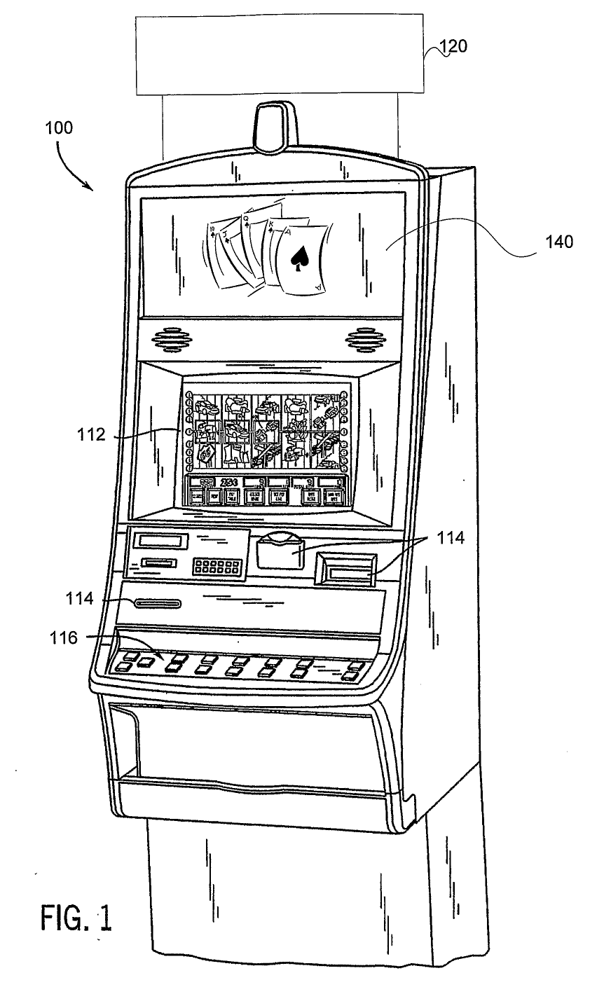

FIG. 1 illustrates an example gaming machine 100 in which may be included various embodiments of the invention. In some embodiments, gaming machine 100 is operable to conduct a wagering game. These wagering games may include reel based wagering games such as mechanical or video slots, card based games such as video poker, or other types of wagering games such as video keno, video bingo or a video dice game. If based in video, the gaming machine 100 includes a video display 112 such as a cathode ray tube (CRT), liquid crystal display (LCD), plasma, or other type of video display known in the art. In the illustrated embodiment, the gaming machine 100 is an “upright” version in which the display 112 is oriented vertically relative to a player. Alternatively, the gaming machine may be a “slant-top” version in which the display 112 is slanted at about a thirty-degree angle toward the player. Further, the gaming machine may be a “bar-top” version in which the display is mounted horizontally in a bar top or table top. Still further, the gaming machine may housed in a wall mounted or other vertically mounted cabinet.

The gaming machine 100 includes a plurality of possible credit receiving mechanisms 114 for receiving credits to be used for placing wagers in the game. The credit receiving mechanisms 114 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the gaming machine 100 includes a user interface comprising a plurality of push-buttons 116, and other possible devices. The plurality of push-buttons 116 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. A touch screen overlaying video display 112 may define touch keys for implementing many of the same functions as the push-buttons. Additionally, in the case of video poker, the touch screen may implement a card identification function to indicate which cards a player desires to keep for the next round. Other possible user interface devices include a keyboard and a pointing device such as a mouse or trackball.

In some embodiments, gaming machine 100 includes a top box 140. Top box 140 may contain a video display, a mechanical display, or a diorama display that supplements display 112. For example, the display in top box 140 may be a wheel such as a rotating wheel, mechanical dice, a board for a board game, or other such display.

A processor controls operation of the gaming machine 100. In response to receiving a wager and a command to initiate play, the processor randomly selects a game outcome from a plurality of possible outcomes and causes the display 112 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the CPU awards the player with a number of credits associated with the winning outcome.

In some embodiments, gaming machine 100 may include signage 120. Signage 120 may be a display device capable of displaying advertising, gaming information (e.g. type of game, denomination of game etc.) or other information to a player or potential player.

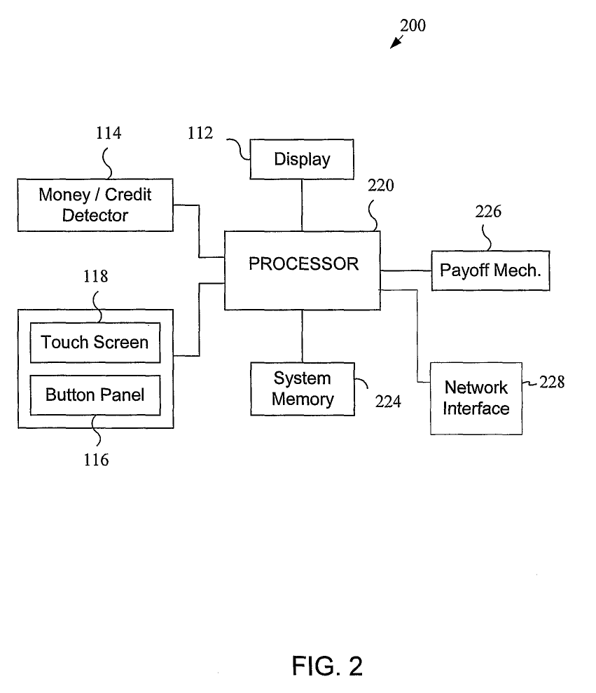

FIG. 2 is a block diagram of a control system 200 suitable for operating the gaming machine 100. Money/credit detector 222 signals a processor 220 when a player has inserted money, tickets, tokens, cards or other mechanism for obtaining credits for plays on the gaming machine through credit mechanisms 114. Using a button panel 116 and/or a touch screen 218, the player may select any variables associated with the wagering game and place his/her wager to purchase a play of the game. In a play of the game, the processor 220 generates at least one random event using a random number generator (RNG) and provides an award to the player for a winning outcome of the random event. Alternatively, the random event may be generated by a remote computer using an RNG or pooling schema and then transmitted to the gaming machine. The processor 220 operates the display 112 to represent the random event(s) and outcome(s) in a visual form that can be understood by the player. In addition to the processor 20, the control system may include one or more additional slave control units for operating the display 112 and any secondary displays.

System memory 224 stores control software, operational instructions and data associated with the gaming machine. In some embodiments, the system memory 224 comprises a separate read-only memory (ROM) and battery-backed random-access memory (RAM). However, it will be appreciated that the system memory 224 may be implemented on any of several alternative types of memory structures or may be implemented on a single memory structure. For example, memory 224 may comprise multiple banks of memory, including RAM, compact flash, hard drives, CD-ROM drives, DVD-ROM drives and combinations thereof.

A payoff mechanism 226 is operable in response to instructions from the processor 220 to award a payoff to the player. The payoff may, for example, be in the form of a number of credits. The number of credits is determined by one or more math tables stored in the system memory 224. As noted above with respect to FIG. 1, the payoff mechanism may be a coin hopper, a ticket printer, a magnetic card writer, or a database update mechanism that updates a database maintaining account information.

Network interface 228 operates to communicably couple system 200 in gaming machine 100 to a network. The network may be any type of wired or wireless network and the network interface 228 may vary based on the type of network. In some embodiments, the network comprises a gaming establishment network such as a LAN (local area network). In alternative embodiments, the network may be an intranet linking multiple networks, for example, the networks of a gaming enterprise that operates multiple gaming establishments. In further alternative embodiments, the network may comprise the Internet.

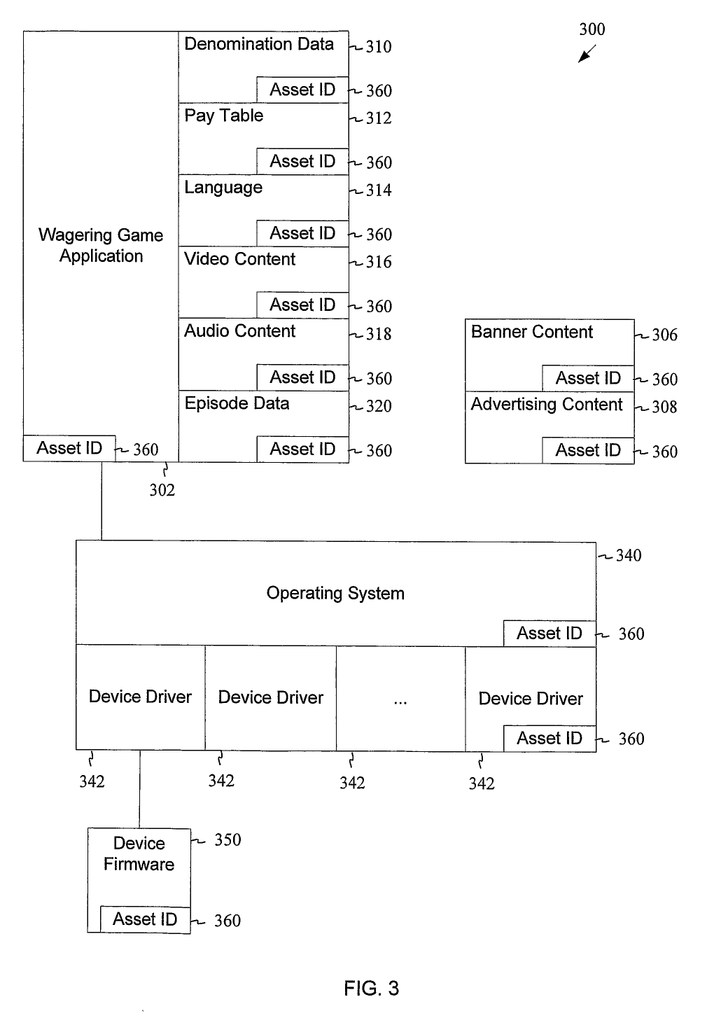

FIG. 3 illustrates various software executable and data components 300 that may operate on a gaming machine 100. These components comprise software assets for the gaming machine. In some embodiments, these components include wagering game application 302, game content and data 306-320, operating system 340, device driver 342 and device firmware 350.

Operating system 340 controls the execution of tasks, processes and applications (e.g. wagering game application 302) running on a gaming machine, and provides interfaces between applications and the hardware present on a gaming machine. The operating system may be proprietary to the gaming machine manufacturer or owner, or the operating system may be provided by a third party. Examples of operating systems that may run within the gaming machine environment include the Microsoft Windows family of operating systems, variants of the UNIX operating system, Linux, and real-time operating systems such as VRTX and QNX. The embodiments are not limited to any particular operating system.

Device driver 342 provides a software interface to hardware that may be present on a gaming machine and software that desires to utilize such hardware, such as a wagering game application 302. Typically a device driver is a software component that is added to the operating system software, and must be designed to provide interfaces expected by the operating system. A different device driver 342 typically exists for each type of hardware present on a gaming machine. For example, a ticket printer may have a device driver, a credit acceptor may have a different device driver etc.

Device firmware 350 comprises software that may be downloaded onto a persistent memory resident on a device that may be a component of gaming machine 100. For example, a ticket printer may include an embedded processor that executes software or reads data from firmware on a flash memory resident on the ticket printer. Other devices that are part of gaming machine 100 may also have firmware to control the operation and interface to the device.

Wagering game application 302 comprises software that controls the execution of a wagering game on gaming machine 100. For example, the wagering game application may provide a slot machine application (video or mechanical), keno, card based wagering games (e.g. poker), dice based wagering games or other types of wagering games. The embodiments are not limited to a particular wagering game application.

Wagering game 302 may include one or more data or executable components. These components include denomination data 310, pay table 312, language data 314, video content 316, audio content 318, and episode data 320. Denomination data 310 includes data that determines the denomination or denominations that the gaming machine uses to determine the amount of a wager. For example, a gaming machine may accept payment for credits in units of $0.25, $0.50, $1.00, $5.00 or other amounts. In addition, denomination data 310 also determines the currency for the wagered amount. For example, the currency may be United States dollars, French francs, Euros or other currency.

Pay table 312 may be used to determine which outcomes are winning outcomes and the amount to be credited or paid out for the various winning outcomes. Pay table 312 may be a single table in some embodiments. In alternative embodiments, multiple pay tables may be present on a gaming machine and vary depending on which game or game version is currently in use.

Language data 314 comprises one ore more data sets or files that contain text to be displayed on the gaming machine. The use of language data 314 allows a wagering game application to display text in the language common the location where the gaming machine is used without requiring customization of the wagering game application.

Video content 316 comprises video data that may be displayed by wagering game application during the course of wagering game play or in an attract mode of the gaming machine. For example, video content may comprise video clips that are displayed to the user during game play, during a bonus round, or while the gaming machine is in attract mode.

Audio content 318 comprises audio data that may be played by the wagering game application during the course of wagering game play, bonus round play, or in an attract mode of the gaming machine. In some embodiments, the audio content may be part of an audio program played on multiple gaming machines to produce a surround-sound effect.

In some embodiments, a portion of video content 316 or audio content 318 may be provided by a gaming establishment and played during game play or in attract mode. This allows the gaming establishment to tailor a gaming machine for their environment. For example, the gaming establishment may desire to provide video or audio content having a theme that is consistent with a theme within the gaming establishment as a whole.

Episode data 320 provides configuration data regarding episodes for a game. In some embodiments, the wagering game may be presented to the user in episodes. For example, bonus rounds may vary depending on the episode, or symbols and characters displayed during game play or game play rules may vary with each episode. Additionally, in some embodiments, some or all of video content 316 and audio content 318 may vary depending on the current episode. Episode data 320 may be used to determine which episode is currently presented to the user.

In addition to wagering game application related software assets, a gaming machine may have other types of configuration components. In some embodiments, these components include banner content 306 and advertising content 308. Banner content 306 comprises content intended to be displayed on a secondary display or overhead sign for a gaming machine. The banner content may be displayed on a single gaming machine, or it may be content designed to be displayed as part of the content for multiple gaming machines. For example, the content may be displayed in a manner such that the content appears to travel from one machine to the next. Alternatively, the content may be one portion of a message that is displayed across multiple gaming machines.

Advertising content 308 comprises advertising video, audio, or text data that may be played or displayed on a gaming machine.

Each of the above-described software assets may have an asset identification 360 associated with it. The asset identification may be a unique string of alphanumeric symbols that may be used to identify a particular version of a particular software asset. As an example, an asset identification 360 may comprise a part number for the software asset. In some embodiments, the asset identifier is imbedded as part of the software asset. However, other means of associating a software asset with an asset identifier are possible and within the scope of the inventive subject matter. For example, the asset identifier may be part of a file name for the software asset.

Various combinations of the above-described software assets may be downloaded onto a gaming machine. It should be noted that no embodiment requires that all of the above-described software assets be downloadable, rather varying embodiments will provide for the download of varying combinations of one or more of the above-described software assets.

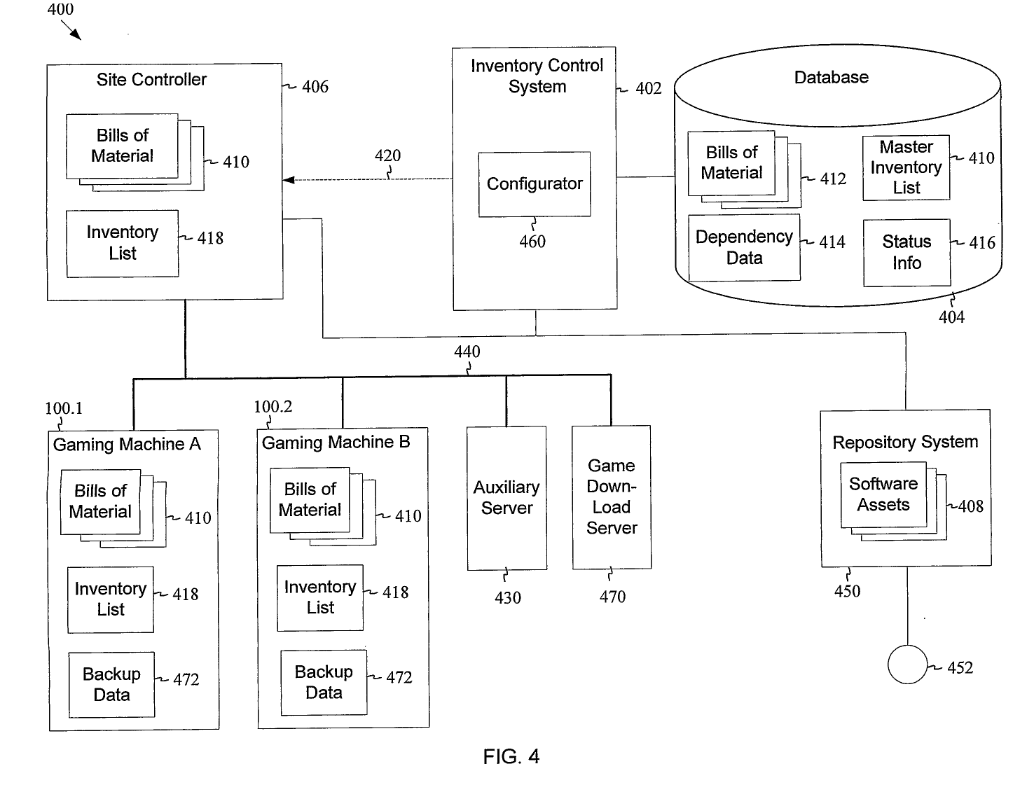

FIG. 4 illustrates various components of a gaming machine system 400 in which embodiments of the invention may be incorporated. In some embodiments, the gaming machine system includes inventory control system 402, site controller 406 and gaming machines 100. Site controller 406 and gaming machines 100 may be communicably coupled via network 440. Network 440 may be a wired or wireless network, or a combination of wired and wireless networks. In some embodiments, network 440 is a gaming establishment local area network. In alternative embodiments, network 440 may be a network that links multiple gaming establishments or facilities. In further alternative embodiments, network 440 may include the Internet. In some embodiments, inventory control system may be communicably coupled via network 420 to site controller 406. Network 420 may be a wired or wireless network, and may be a corporate network or the Internet.

In some embodiments, inventory control system 402 maintains a database 404 of software assets available for loading on gaming machines. Inventory control system 402 may be what is known as an Enterprise Resource Planning (ERP) system. As noted above, the software assets may be identified using an asset identifier. Although shown as one entity for convenience, database 404 may be comprised of multiple databases. Further, database 404 may be a relational database, hierarchical database, object oriented database, XML database or a set of one or more files in a file system and combinations of the above. In some embodiments, database 404 may include master inventory list 410, one or more bills of material 412, dependency data 414 and status information 416.

Master inventory list 410 comprises a list of the software assets that are available to be loaded onto one or more gaming machines or gaming related systems. The inventory list 410 typically includes a name of the asset as well as an asset identifier and may also include a brief description of the software asset. Master inventory list 410 may also include other types of assets. For example, master inventory list 410 may include lists of parts for gaming machine hardware.

A bill of material comprises a list of software assets that may be part of a logical grouping of software assets. The grouping may be based on a variety of factors. For example, the grouping may include all of the software components that are loaded on a gaming machine. Alternatively, the grouping may include the software components for a bonus round of a gaming machine. Further, the grouping may include the software components for a particular episode for a gaming application having episodic game. The embodiments are not limited to any particular methodology for grouping software assets into a bill of materials, and various embodiments may use a combination of one or more methods of grouping software assets into a bill of materials.

Additionally, a bill of material may include one or more other bill of materials such that there is a hierarchy of bills of material. For example, a first bill of material may represent the software assets for a gaming application. Included in this bill of material may be bills of material for each bonus round in the gaming application. Further bills of material may be referenced for each episode for an episodic gaming application. In cases where one bill of material includes other bills of material, the other bills of material may have asset identifiers associated with them wherein the asset identifier is associated with the group of software assets, each of which may also have an asset identifier.

Some embodiments of the invention include dependency data 414. Dependency data 414 comprises data that identifies dependency regarding assets to be used for a gaming machine or gaming related system. A variety of different types of dependencies are possible and within the scope of the inventive subject matter. For example, the dependencies may comprise software-software dependencies in which one software component is dependent on the presence of another software component, or version of a software component. For instance, an audio file may depend on a software component that can play the audio file.

Another example of a dependency is a software-hardware dependency in which a software component may be dependent on the existence of a particular hardware component in order to function properly. For instance, a software component for a video card game may require the presence of a hardware button panel having at least 8 buttons.

A further example of a dependency is a hardware-hardware dependency in which one piece of hardware may require the presence of other hardware in order to function properly. For example, in order to mount a ticket printer in a gaming machine a particular type of hardware mounting bracket may be required.

The above examples of dependencies are meant to be illustrative, those of skill in the art will appreciate that many types of dependencies may exist and are within the scope of the inventive subject matter.

Status information 416 may include information regarding the current state of a gaming machine. For example, status information 416 may include the hardware present on the machine. This information may be useful to determine if software to be downloaded to a gaming machine is compatible with the hardware present on the gaming machine. Further, the status information may be used in conjunction with dependency data 414 to determine if the prerequisite software or hardware is present on a gaming machine before new or updated software assets are configured for loading on the gaming machine or gaming related system. In some embodiments, status information 416 is periodically updated with information from a gaming machine. In some embodiments, the status information is polled are periodic intervals. In alternative embodiments, a gaming machine may send status information when it is idle (i.e. not in use by a wagering game player). In further alternative embodiments, a gaming machine may send status information when a cabinet door is opened or closed. In such embodiments, the opening or closing of a cabinet door may indicate that new or updated hardware has been placed in the machine.

In some embodiments, inventory control system 460 may include a configurator 460. Configurator 460 provides a user interface to aid a user in creating and managing software assets for gaming machines and gaming related systems. Configurator 460 may use elements from database 404 to aid the user in creating and manage configurations. For example, configurator 460 may access dependency data 414 in order to determine if a user has specified a configuration of software assets for inclusion in a bill of materials that includes the correct prerequisite software. Further, configurator may access status data 416 in order to determine if prerequisite hardware is available on a gaming machine that is being configured with new or updated software assets.

Site controller 406 comprises a computer system that may interact with one or more gaming machines at a gaming establishment such as a casino. Site controller 406 may store software assets for download onto gaming machines 100. In addition, in some embodiments site controller 406 stores bills of materials for software assets that have been loaded onto one or more gaming machines 100, and tracks which bills of materials are associated with a particular gaming machine 100. When software assets are available for download, site controller 406 may compare asset identifiers for the software assets with asset identifiers in the bills of materials in order to determine if a gaming machine already has some or all of the software assets already loaded onto the gaming machine. Alternatively, site controller 412 may maintain an inventory list 418 of software assets that have been loaded onto a gaming machine 100. The inventory list 418 is similar to a bill of material 410, however the inventory list 412 may be list of all the software assets that have been loaded, including assets listed on one or more previous bills of material. In other words, rather than keeping multiple separate bills of materials for software assets that have been loaded onto a gaming machine 100 over time, site controller 406 may maintain a single inventory list 418 containing the same information (e.g. software asset identifiers) that would have been found on the multiple bills of material.

In alternative embodiments, gaming machines 100 maintain bills of materials 410 and/or inventory lists 418 for software assets that have been loaded onto the gaming machine. In these embodiments, an individual gaming machine 100 may determine whether or not some or all of the software assets in a new bill of material need to be downloaded based on whether previous bills of material 410 or the inventory list 412 indicate that the software assets have already been loaded.

In some embodiments, system 400 includes an auxiliary server 430. Auxiliary server 430 may be any type of server coupled to network 440 that provides gaming related services. For example, auxiliary server 430 may be a progressive server that manages a progressive wagering game in which multiple gaming machines contribute to a pool of potential winnings that may be paid out to any gaming machine participating in the progressive wagering game upon certain outcomes. Alternatively, auxiliary server 430 may be an overhead sign controller that controls the display of overhead signs in a gaming establishment. Other types of auxiliary servers are within the scope of the inventive subject matter. In these embodiments, site controller 406 may maintain bills of material 410 or inventory lists 418 for these auxiliary servers 430. Alternatively, the auxiliary server 430 may maintain its own bills of material 410 or inventory lists 418 in the same manner as described above for gaming machines 100.

Some embodiments include a repository system 450. Repository system 450 may be a system that stores and maintains downloadable assets 408 for distribution to gaming machines 100. Downloadable software assets may include any combination of one or more of the software and data components 300 illustrated in FIG. 3. Distribution of the downloadable software assets 408 may be over a network connecting repository system 450 to site controller 406, such as a gaming establishment corporate network or intranet. However, other methods of distribution are possible. For example, repository system 450 may be a software manufacturing based system and software assets 408 and bills of materials may be loaded onto a disk 452 such as a CD-ROM or DVD-ROM to be delivered to a gaming establishment for loading onto a site controller 406 or gaming machine 100.

In some embodiments, one or more gaming machines 100 may be configured to store backup data 472. Backup data 472 may comprise any type of backup data. In some embodiments, backup data 472 may include a backup of any of the downloadable software components 300 illustrated in FIG. 3. Thus in some embodiments, the backup data provides a secondary source for software components 300 or other downloadable assets 408. The backup data may provide a secondary backup source for a site controller 406, a repository system 450, or an inventory control system 402.

In some embodiments, gaming machines 100 may obtain software downloads from a game download server 470 communicably coupled to network 440. In these embodiments, backup data 472 may comprise a secondary source of downloadable software components that are ordinarily obtained from game download server 470.

Additionally, backup data 472 may comprise data that is saved during the operation of gaming machines, such as accounting data, game history data, or other data that is useful in operating gaming machines and gaming establishments.

Backup data 472 may comprise a integral data backup, that is, backup data 472 may be a complete backup copy of data stored on a site controller 406, an inventory control system 402, repository system 450 or game download server 470. Alternatively, backup data 472 may be a distributed data backup, where backup data from the primary source (e.g. site controller 406, an inventory control system 402, repository system 450 or game download server 470) is stored across multiple gaming machines 100, wherein each gaming machine 100 stores a portion of the complete set of backup data.

Systems that are configured to receive data from a primary source may also be configured or issue queries to determine where the backup data 472 is located in the event that the data is not available from the primary source.

Providing a secondary source for data and downloadable software assets 408 such as backup data 472 on gaming machine 100 is beneficial because doing may provide a more robust and error free operation of a gaming network. Additionally, providing backup data 472 on gaming machines 100 may provide a means to meet regulatory requirements of providing a secondary storage of downloadable gaming software and data outside of a protected room without having to add additional computer systems such as server system on a gaming network.

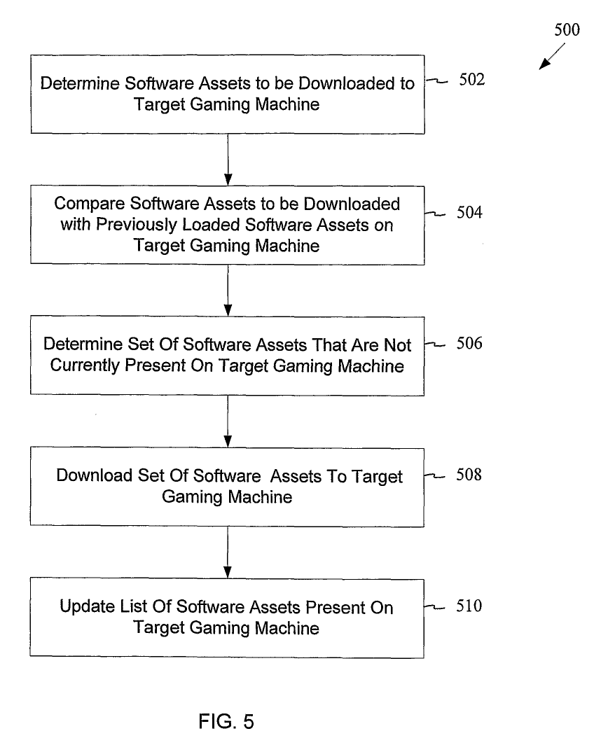

FIG. 5 is a flowchart illustrating methods for managing software components for gaming machines according to various embodiments of the invention. The methods to be performed by the operating environment constitute computer programs made up of computer-executable instructions. Describing the methods by reference to a flowchart enables one skilled in the art to develop such programs including such instructions to carry out the method on suitable processors for gaming machines (the processor or processors of the computer executing the instructions from computer-readable media). The methods illustrated in FIG. 5 are inclusive of acts that may be taken by an operating environment executing an exemplary embodiment of the invention.

The method begins by determining software assets are to be downloaded to a target gaming machine (block 502). The new software assets may comprise a new gaming application, or an update for a previously loaded gaming application such as a new or updated bonus round, a new episode for an episodic gaming application, a new pay table, new denomination etc. The embodiments of the invention are not limited to a particular type of software asset. The determination of software assets may be made by examining a bill of materials identifying the software assets.

Next, the system compares the software assets to be downloaded with software assets that have been previously loaded on the target gaming machine (block 504). In some embodiments, the comparison may be accomplished by comparing a bill of materials with one or more bills of material for the previously loaded software assets. In alternative embodiments, the comparison may be accomplished by comparing a bill of materials with an inventory list including software that has been previously loaded. The comparison will typically involve comparing asset identifiers on the bills of material or inventory list.

It should be noted that the previously loaded software may or may not have been previously downloaded onto the target gaming machine. In some embodiments, the previously loaded software may have been placed in a persistent memory of the gaming machine when the gaming machine was manufactured. Alternatively, the previously loaded software may have been loaded onto the gaming machine from a disk. In either case, the bill of materials or inventory list for the previously loaded software will identify the software assets currently existing on the gaming machine.

Based on the comparison at block 504, the system will then determine a set of software assets available for download that are not currently loaded on the gaming machine (block 506). This set of software assets may then be downloaded to the gaming machine (block 508). Software assets that are available for download, but are currently already loaded on the gaming machine need not be downloaded.

Finally, in some embodiments, a list of software assets that are present on the target gaming machine is updated to reflect the newly downloaded software assets. This updated list may then be used in the future to compare newly available packages of software assets with assets already on the gaming machine.

In some embodiments, a bill of materials may include an identification of a source for downloading the software assets that are not currently present on the target gaming machine. The source may be a site controller, a software repository system, or another gaming machine that already has the software asset or assets loaded on it.

Downloading of assets onto a target gaming machine may be initiated by the gaming machine itself, for example in a pull mode where software assets that have been identified as missing from the gaming machine are pulled from an asset source. Alternatively, downloading of assets onto a gaming machine may be initiated by different machine from the target gaming machine, for example in a push mode where software assets that have been identified as missing are pushed onto the target gaming machine.

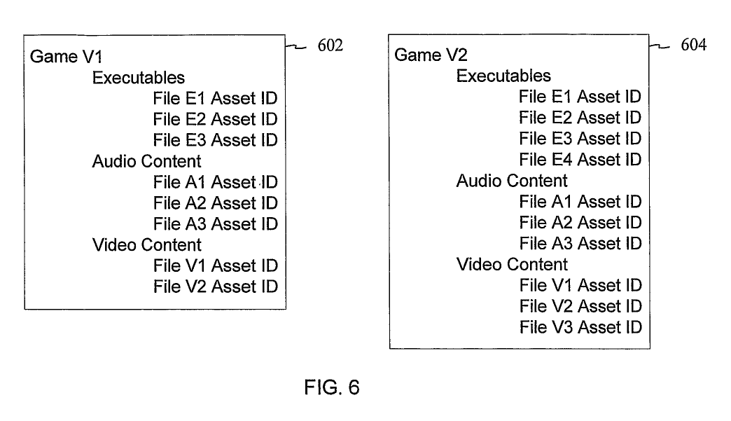

FIG. 6 provides two example lists of software components that may be used to illustrate the operation of embodiments of the invention. List 602 comprises a bill of materials for a set of software assets for version one of a gaming application that have been previously loaded on a gaming machine. List 602 is shown as a simple hierarchical list and includes asset identifiers for the executable files, audio content files, and video content files for version one of the gaming application.

List 604 comprises a bill of materials for a set of software assets included in version two of the gaming application. The new version may represent new features, new bonus rounds, new episodes, or problem fixes. In the new version, two files have been added, an executable file E4 and a video content file V3. During the execution of the method described above, the system will determine based on the asset identifiers that files E4 and V3 are not currently present on the target gaming machine and will proceed to download the new files to the target gaming machine.

It should be noted that a relatively simple hierarchy has been shown to avoid obscuring the inventive subject matter. Those of skill in the art will appreciate that a bill of materials or other inventory list may include many different levels, and as noted above the hierarchy may include other bills of materials or inventory lists.

### Conclusion

Systems and methods for managing software assets on a gaming machine or gaming related system have been described. Although specific embodiments have been illustrated and described herein, it will be appreciated by those of ordinary skill in the art that any arrangement which is calculated to achieve the same purpose may be substituted for the specific embodiments shown. The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that the inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope or meaning of the claims.

1. A method for administering content on a gaming machine, the method comprising:
determining a list of software assets capable of being loaded onto a gaming machine as part of a predefined package of software assets;
comparing the list of software assets to a list of previously loaded software assets; and
identifying a subset of the software assets that are not present in the previously loaded software assets based on the comparison.

2. The method of claim 1, further comprising loading the subset of software assets that are not present onto the gaming machine.

3. The method of claim 1, wherein the list of software assets comprises a bill of materials for the predefined package of software assets.

4. The method of claim 1, wherein the list of previously loaded software assets comprises at least one bill of materials for the previously loaded software assets.

5. The method of claim 1, further comprising identifying a source for at least one software asset in the subset of the software assets not present in the previously loaded software assets.

6. The method of claim 5, further comprising downloading the at least one software asset to a gaming machine.

7. The method of claim 6, further comprising:
notifying the gaming machine of the source of the at least one software asset; and
initiating the download by the gaming machine.

8. The method of claim 6, wherein a site controller retrieves the at least one software asset and initiates downloading the at least one software asset to the gaming machine.

9. The method of claim 5, wherein the source for at least one software asset comprises a gaming machine having a backup data including the at least one software asset.

10. The method of claim 1, wherein the software assets include an asset selected from the group consisting of banner content, advertising content, denomination, pay table, language data, video content, audio content, episodic game data, wagering game software, operating system software, device driver software, and device firmware.

11. The method of claim 1, further comprising determining whether at least one of the software assets depend on the presence of at least one gaming machine component.

12. The method of claim 11, wherein the gaming machine component comprises a hardware component.

13. The method of claim 11, wherein the gaming machine component comprises a software component.

14. A gaming system comprising:
an inventory control system to maintain asset identifiers for a set of software assets for one or more gaming machines and to generate a bill of materials for a gaming machine component;
a gaming machine operable to receive a subset of the set of software assets, the subset being determined by comparing asset identifiers in the bill of materials to asset identifiers for previously loaded software assets.

15. The gaming system of claim 14, wherein the asset identifiers for previously loaded software assets are provided on one or more previously generated bills of material.

16. The gaming system of claim 15, wherein the gaming machine is operable to compare asset identifiers in the bill of materials to asset identifiers for previously loaded software assets.

17. The gaming system of claim 14, further comprising a site controller operable to compare asset identifiers in the set of software assets to asset identifiers for previously loaded software assets.

18. The gaming system of claim 17, wherein the site controller is operable to store the set of software assets and download the assets to the gaming machine.

19. The gaming system of claim 14, further comprising a dependency database in communication with the inventory control system, the dependency database having dependency data regarding gaming machine components and wherein the inventory control system is operable to query the dependency database to determine if at least one of the software assets is dependent on at least one of the gaming machine components.

20. The gaming system of claim 19, wherein the at least one gaming machine component comprises a hardware component.

21. The gaming system of claim 19, wherein the at least one gaming machine component comprises a software component.

22. A computer-readable medium having computer executable instructions for performing a method for administering content on a gaming machine, the method comprising:
determining a list of software assets capable of being loaded onto a gaming machine as part of a predefined package of software assets;
comparing the list of software assets to a list of previously loaded software assets; and
identifying a subset of the software assets that are not present in the previously loaded software assets based on the comparison.

23. The computer-readable medium of claim 22, wherein the method further comprises loading the subset of software assets that are not present onto the gaming machine.

24. The computer-readable medium of claim 22, wherein the list of software assets comprises a bill of materials for the predefined package of software assets.

25. The computer-readable medium of claim 22, wherein the list of previously loaded software assets comprises at least one bill of materials for the previously loaded software assets.

26. The computer-readable medium of claim 22, wherein the method further comprises identifying a source for at least one software asset in the subset of the software assets not present in the previously loaded software assets.

27. The computer-readable medium of claim 26, further comprising downloading the at least one software asset to a gaming machine.

28. The computer-readable medium of claim 27, wherein the method further comprises:
notifying the gaming machine of the source of the at least one software asset; and
initiating the download by the gaming machine.

29. The computer-readable medium of claim 27, wherein a site controller retrieves the at least one software asset and initiates downloading the at least one software asset to the gaming machine.

30. The computer-readable medium of claim 22, wherein the software assets include an asset selected from the group consisting of banner content, advertising content, denomination, pay table, language data, video content, audio content, episodic game data, wagering game software, operating system software, device driver software, and device firmware.

31. The computer-readable medium of claim 22, further comprising determining whether at least one of the software assets depend on the presence of at least one gaming machine component.

32. The computer-readable medium of claim 31, wherein the gaming machine component comprises a hardware component.

33. The computer-readable medium of claim 31, wherein the gaming machine component comprises a software component.
